(19) United States
(12) Patent Application Publication
(10) Pub. No.: US 2025/0291891 A1
(43) Pub. Date: Sep. 18, 2025

(54) PLATFORM SYSTEM CREATING RELIABLE, TRUST SCORED, TRUSTWORTHY DATA, FROM HUMAN AND OTHER DATA SOURCES FOR TRUSTED USES BY INDIVIDUALS AND OTHER ENTITIES

(71) Applicant: Platform Veritas Inc., Dover, DE (US)

(72) Inventors: David William Kravitz, San Jose, CA (US); Donald Houston Graham, III, Clearwater, CA (US); Thomas Charles Burton, Ventura, CA (US)

(21) Appl. No.: 19/061,897

(22) Filed: Feb. 24, 2025

Related U.S. Application Data
(63) Continuation-in-part of application No. 18/226,357, filed on Jul. 26, 2023, now abandoned.
(63) Continuation-in-part of application No. 18/766,605, filed on Jul. 8, 2024.
(60) Provisional application No. 63/392,236, filed on Jul. 26, 2022.
(60) Provisional application No. 63/436,405, filed on Dec. 30, 2022.
(60) Provisional application No. 63/544,324, filed on Oct. 16, 2023.
(60) Provisional application No. 63/658,850, filed on Jun. 11, 2024.
(60) Provisional application No. 63/712,443, filed on Oct. 26, 2024.
(60) Provisional application No. 63/745,608, filed on Jan. 15, 2025.

(51) Int. Cl. G06F 21/44

(52) U.S. Cl. CPC G06F 21/44

(57) ABSTRACT

A system for the creation of trust-scored, trustworthy data typically where devices of users are authenticated; where user-posted data becomes content within system-defined digital objects which are user-signed; where posted user-claimed facts are supported by user-posted visible evidence; where relationships between facts and visible evidence are identified by user-signed proprietary t-tags; where hashes of signed objects and t-tags are recorded on blockchain; where posted data has been trust-scored by the system; where users may collaboratively post, produce and align trustworthy data thereby preferably creating new knowledge; where nefarious users with low trust scores become no longer visible to other users on the system; where system trustworthy data system may be used for multiple purposes, preferably improving the trustworthiness of AI systems by users to preferably making trustworthy data available to AI systems, in different embodiments to challenge inadequate AI responses, and/or provide generally quality control actions upon AI systems.

### CROSS-REFERENCE TO RELATED APPLICATIONS

This patent application claims benefit of provisional application No. 63/745,608, filed on Jan. 15, 2025, and provisional application No. 63/712,443, filed on Oct. 26, 2024, and is a continuation-in-part of application Ser. No. 18/766,605, filed on Jul. 8, 2024, which claims benefit of provisional application No. 63/658,850, filed on Jun. 11, 2024, and provisional application No. 63/544,324, filed on Oct. 16, 2023 and patent application Ser. No. 18/226,357, filed on Jul. 26, 2023, which claims benefit of provisional application No. 63/436,405, filed on Dec. 30, 2022 and provisional application No. 63/392,236, filed on Jul. 26, 2022.

### FIELD OF THE INVENTION

The creation of a system or platform using data source: authentication methods; attribution with digital signing; immutability with blockchain; collaboration amongst system users; and trust scoring methods of posted data to thereby produce trustworthy data. Also, the use of such trustworthy data for multiple purposes, one of which being a method to apply quality control actions on large language models.

### BACKGROUND OF THE INVENTION

This invention relates to the creation of a system producing trust-scored, trustworthy data. In today's world it can be challenging for individuals and groups to identify sources of reliable information and data that they can trust. Too much publicly available information can be found to be infected by “disinformation”, “misinformation” and/or outright falsehoods. Even data from artificial intelligence systems can found to be less than reliable. This invention aims to move towards a system where individuals can benefit from confidently having and using trustworthy data, as well as from having tools for multiple purposes, one of which is a method to apply quality control actions on large language models.

### SUMMARY OF THE INVENTION

The invention preferably consists of two general components. The first is a Curated Data Repository and Evaluation System (“CDRE”) which preferably produces trust-scored, trustworthy data. CDRE elements and design preferably will be disclosed herein. The second general component of the invention is preferably using the CDRE technology, together with various embodiments of trust-scored, trustworthy data produced by a CDRE for disclosed interactions with artificial intelligence systems, including in various embodiments with large language models (LLMs). Typically, such interactions may involve LLMs through use of one or both System Instructions and RAG (Retrieval Augmented Generation) methods.

### DETAILED DESCRIPTION OF THE INVENTION

In one embodiment, a system (or platform) may incorporate one or more Curated Data Repository and Evaluation system (“CDRE system” or “CDRE”) as generally described herein. A CDRE may be offered as an element in a cloud platform accessible to its users over the Internet or possibly through a network connection or possibly as a system operating within a data center or in another environment or another embodiment.

In another embodiment, a CDRE system may become available in association with a data lake or comparable data-storage facility [FROM WIKIPDEIA: “A data lake is a system or repository of data stored in its natural/raw format, usually in a large, binary object “blobs” or files. A data lake is usually a single store of data including raw copies of source system data, sensor data, social data etc., and transformed data used for tasks such as reporting, visualization, advanced analytics and machine learning “]. Or other embodiments.

In some embodiments users might only have access to view a typically specified CDRE system information while in other embodiments users may become authenticated and/or approved within a CDRE system and may gain additional rights, such as in one embodiment to submit and/or comment on data in a CDRE system. Users may preferably enter data into a CDRE system by submitting to it, typically in the format of an object, in conformance with a CDRE system information category organizational arrangement and/or other requirements.

User submitted data should typically be provided in the form of signed, digital objects provided by individual users. A CDRE system may typically provide a digital template for users to follow in their object submission process.

In one embodiment, such as a data lake administrative server, an administrator of such may become a user of the system and may submit bulk quantities of digital objects that may be typically authenticated and/or attributed.

A CDRE system may or may not have a data curation process. A CDRE system may or may not incorporate moderators for categories of data (or other subdivisions of stored information). A moderator function may be human, or in another embodiment may be software-operated, possibly using artificial intelligence technology.

Users may typically interface with a CDRE system by using a CDRE system-provided, and/or system-approved, and/or system-recommended, software application and/or user-controlled device (UCD), and/or alternately an approved browser or other method.

In one embodiment, an app installed on a UCD may typically support an authentication process that results in a preferably unique and preferably unspoofable identity and possibly one or more persona for a user. When permitted by a system, users may typically establish one or more actual or pseudonymous identity or identities for their use on a CDRE system.

An app should typically have or support or be associated with a device root of trust capability on a UCD, which preferably may be operated with device software. Device app or software may typically support encryption and/or digital signing capabilities.

In some cases, a CDRE-approved digital wallet (or other device) may partially or fully suffice for a CDRE-workable UDC with a device root of trust and/or digital signing capability.

An app, typically in combination with an associated device root of trust capability on a UCD, preferably may have or support a capability of creating and/or signing digital objects as generally described herein. In another embodiment app capabilities may be incorporated in a browser plug in.

In another embodiment, an example of a generally acceptable app could be one created by TrustCentral (www.trustcentral.com) with possibly some modifications for use with a CDRE system.

Typically, a user device app could support a digital wallet or possibly associate with a CDRE system supported digital wallet as a method of optionally providing digital verification, signing and/or other functions supporting user interaction with a CDRE system as described herein.

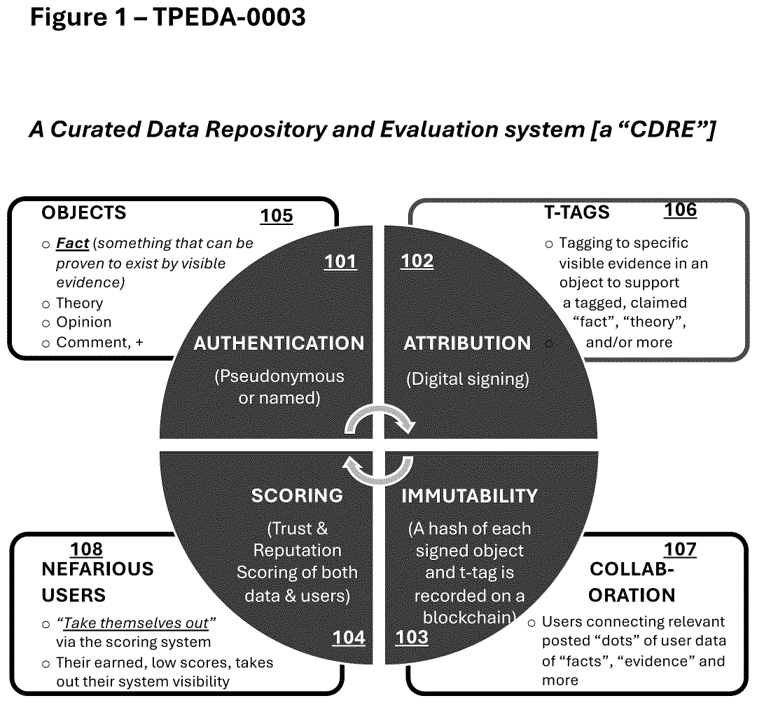

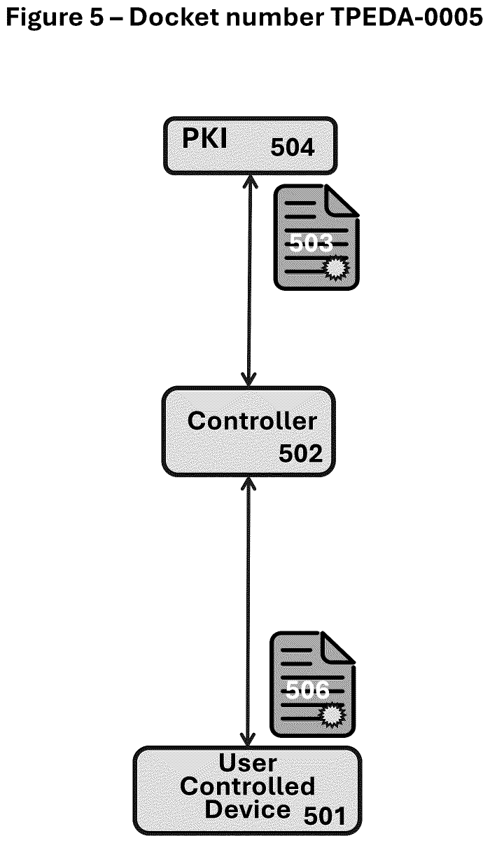

FIG. 1—Discloses general characteristics of a primary element of a system which is generally referred to in this disclosure as a curated data repository and evaluation system (a CDRE). Typically, a CDRE incorporates four general functions (FIGS. 1 101, 102, 103, and 104) and four general activities (FIGS. 1 105, 106, 107, and 108). A user may typically interface with a system through use of a system-approved app installed on a user-controlled device (a UCD). A UCD may preferably be uniquely authenticated FIG. 1 101 within the system (typically in a pseudonymous or named manner). Preferably a system Controller FIG. 5 502 will typically request an attribute certificate FIG. 5 503 be uniquely issued by a PKI FIG. 5 504 for a specific UCD FIG. 5 501 which the Controller will typically provide FIG. 5 506 to the UCD FIG. 5 501. An approved UCD with app may preferably have digital signing capability, thus an ability to provide attribution FIG. 1 102 of digitally signed objects FIG. 1 105 and/or t-tags FIG. 1 106 a UCD may contribute to a system. Typically, a cryptographic hash of such UCD-digitally signed objects and/or t-tags may preferably be created and recorded on a blockchain FIG. 1 103. Various actions of users and/or their data may typically be scored for trust and/or reputation through the system FIG. 1 104. Typical activities of users may include the creation of digital objects FIG. 1 105 and of t-tags FIG. 1 106. Preferably, as users add objects and/or t-tags to the system, they may generally collaborate with other users doing similar activities and preferably identity and/or associate relationships amongst object, t-tags, evidence and/or other FIG. 1 107.

### COLLABORATION

In various embodiments, the activities of collaboration may preferably manifest in or with one or more of these characteristics: Sources of data preferably be cryptographically Authenticated (pseudonymously OK); Digital data preferably conform to a specified format (in one embodiment, a defined digital “Object”); Data types preferably be identified (in one embodiment, “facts”, “theories”, “comments”, etc.); Digitally signed Attributions of posts preferably be by an Authenticated source; Collaborating Users may identify, evaluate and compare data; establish relevancies, relationships and/or importances between posted data; Users preferably collaborate to discover, identify missing “pieces” of data; to identify unknown or false data; to “connect the dots” (using t-tags); Immutability of postings is typically established (using blockchain); Users' results are typically enhanced by Trust Scoring of data and/or of Users; Nefarious Users that post false or poor-quality data typically earn lower trust scores; In various embodiments, through the platform's Trust Scoring system, those low score Users preferably “take themselves out” by their system visibility to other Users typically becoming lowered to them then becoming unseen; Users with bad behavior can also typically be negatively affected by lower Reputation Scores (Reputation Scoring is preferably expected to be particularly effective for dealing with bots); Trust scores of both Users and their posted data are typically transparently visible to others; the system typically supports robust options for both narrative and graphical reporting.

In one embodiment, a collaboration might be identified and preferably be made into a game, in one embodiment, comparable to a video game. Individual users or groups could complete to resolve a targeted goal of a collaboration effort. Possibly rewards could be offered or awarded for achieving goals or targets that may be identified in association with a collaboration. Preferably creating a game may expose a collaboration to a broader audience and/or enhance the success of a collaboration effort.

The system is preferably prepared for some users acting in a nefarious manner of one sort or another FIG. 1 108. Preferably nefarious activities may result in lower trust and/or reputation scores. Preferably, the system (typically including the app and UCD) may operate in such a fashion, that if a user's trust and/or reputation score drops below a default (or other) value, then preferably the activities of such a user may no longer be visible to other system users.

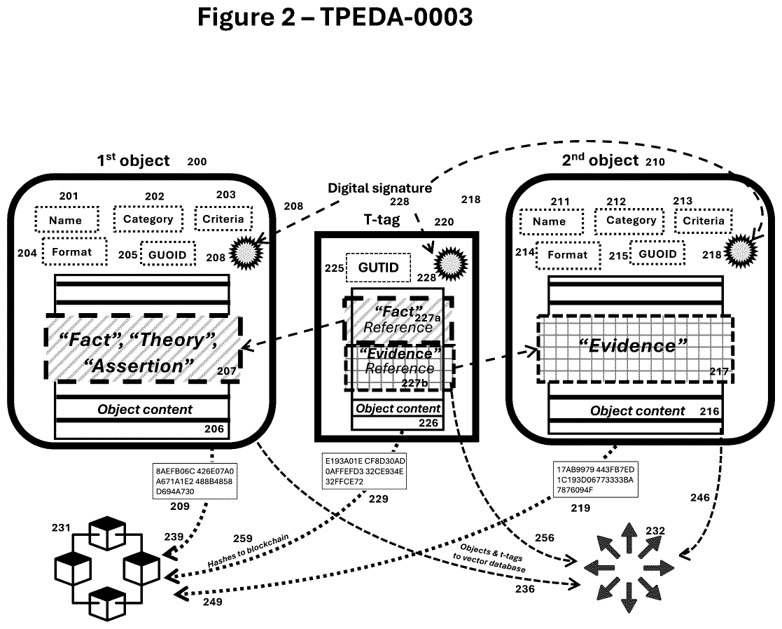

FIG. 2—Primary curated data repository and evaluation system (CDRE) components of the system are generally described in FIG. 2. Shown is a 1^{st} object 200 and a 2^{nd} object 210. As elements of a typical object, there typically exists fields for: name 201, 211; category 202, 212; criteria 203, 213; format 204, 214; GUOID (Globally Unique Object Identifier) 205, 215; user-added content to a typical object 206, 216; a user-identified field for “fact”, “theory”, “assertion”, opinion, comment, or other 207; user-identified “evidence” 217 as appropriate; a user-initiated digital signature 208, 218 which typically completes a user's creation of a signed object. After creating objects., typically a user may preferably create a t-tag 220. A t-tag may typically have a GUTID (Globally Unique T-tag Identifier) and the user may preferably create a reference to a “fact” (or other as appropriate) 227 in a first object 207 as well as a reference to “evidence” associated with such “fact” 226 in a second object 217. While this figure discloses “evidence” being identified in a second object from an associated “fact”, in other embodiments, both the “evidence” and the statement of “fact” may typically be identified in the same object, with a t-tag identifying such. Generally, after completing these steps a user may typically digitally sign the t-tag 228.

Preferably the system may subsequently create hashes of signed objects and/or t-tags 209, 219 and 229 for recordation on a blockchain 231. Also, the signed objects and t-tags may typically become stored in typically, a vector database 232.

### CDRE Objects, Some Details

A user-provided (or other acceptable) object used by a CDRE system is generally a digitally signed package of information in a form of a digital file, created for posting to a CDRE system as generally described in FIG. 2. An object preferably may have a CDRE system prescribed format FIG. 2 200 and incorporate various fields, in one embodiment: object name and/or title (typically user provided) and category (ies) associated with the object. Other fields could be one or more definable types of entry, or other.

In one embodiment of a type of entry for which a user may submit an object could preferably include a criteria field selection FIG. 2 203 with a choice of acceptable CDRE system selectable criteria, such as a Fact, Theory, Opinion, Comment, Misinformation, Malinformation or other. In other embodiments, criteria may include user assertions that the content of an object complies with one or more governmental and/or CDRE system, and/or other applicable rules, regulations and/or laws. Preferably such criteria fields may be in common use amongst objects across much of a CDRE system, and preferably users and/or a CDRE system may be able to query, analyze, select or use such criteria selection in other ways for purposes that may be desirable to users and/or a CDRE system.

While, by definition, neither of the criteria of Theory, Opinion, Comment, Misinformation, Malinformation or other may be the same as a “fact” and neither may have “visible evidence” like a “fact” to demonstrate a level of veracity, however they typically may be associated with “associated evidence” in a similar fashion as to how a “fact” is associated with “visible evidence”. Each may possibly be also separately trust scored within their own separate of these categories preferably relative to typically each's relationship to its “associated evidence”.

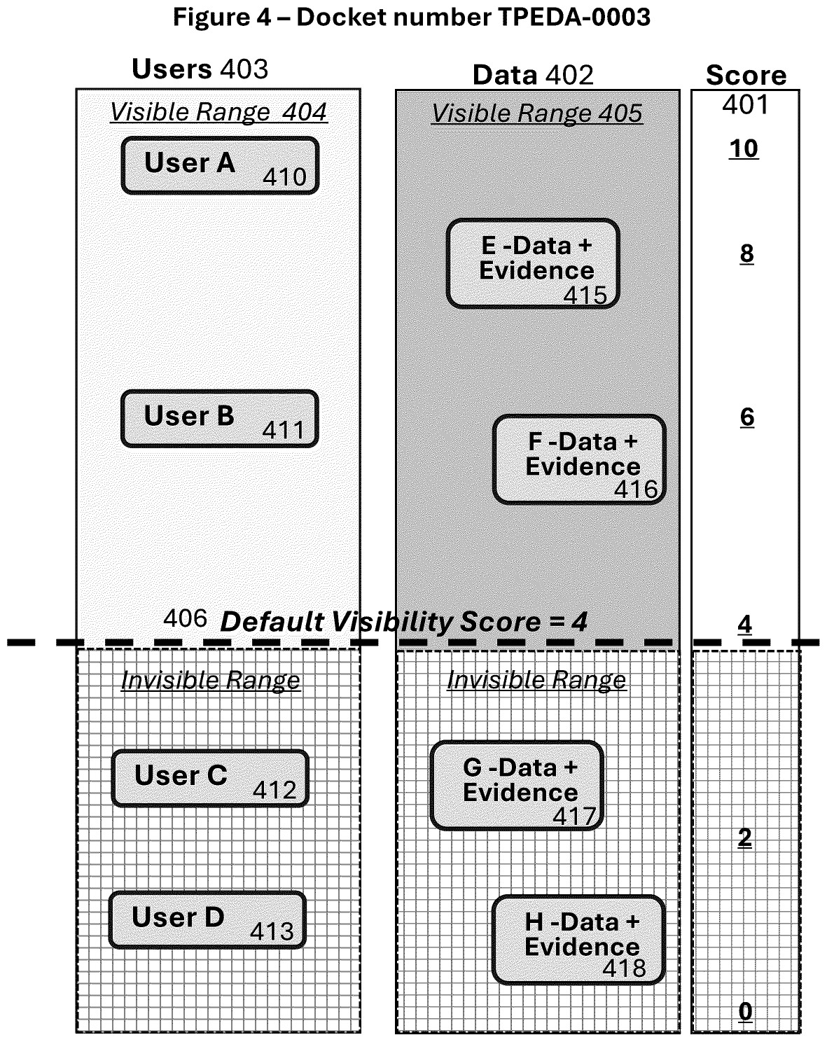

FIG. 4—Discloses important characteristics of a trust scoring system. Effectively the system's Trust Scoring System FIG. 4 typically assigns trust scores to both users FIG. 4 403 and/or user data FIG. 4 402. Trust scores FIG. 4 401 are typically assigned at various levels (in FIG. 4 embodiment for 10 to 0) above or below a system default level FIG. 4 406 (in FIG. 4 401 embodiment is at 4). Preferably when scores are above the default level such users and/or user data (FIG. 4 410, 411, 415, 416) are typically visible to other Users on the Platform. Typically, when trust scores are below the default level such users and/or user data (FIG. 4 412, 413, 417, 418) become invisible to other users on the Platform. Preferably the assignment of low scores to poor user behavior and/or data posts containing outpoints, then nefarious or careless users doing so, essentially “take themselves out”; typically, their Platform visibility by other Users is negatively affected by their lowered trust score, resulting in them becoming unseen or invisible.

In one embodiment, Misinformation handling may be to provide correcting factual visible evidence. Possibly handling misinformation may be to include the identity of who, or what entity, may have declared a statement (or other) to be misinformation. Preferably a misinformation response may include some pre-existing correct information related to the misinformation, because it is generally accurate that a truth generally must exist before a lie (In one embodiment, misinformation) can exist.

A CDRE system may preferably create a global unique object ID (GUOID) FIG. 2 205, 215 to be associated with an object and such GUOID may typically be provided to the user or UCD preferably in the form of a certificate, for association with an object prior to the user digitally signing the object FIG. 2 208, 218 (or in another embodiment, possibly provided by a CDRE system for association with the object, possibly in combination with a CDRE system digital signature).

In one embodiment, an object may be created in a format preferably specified by a CDRE system. Typically, the completed, submitted object should be digitally signed by a user. The signed object may be typically posted to a CDRE system by a user. In one embodiment, a CDRE system may receive an object and inspect it to ensure format compliance with CDRE system requirements prior to a user signing it. Typically, non-complying objects (signed or un-signed) could be returned to the user for correction and possible resubmission. Preferably, the category of a complying object together with it GUOID, with optionally t-tag-supported applicable reference categories and/or reference links that may or may not also be signed by the user, then may be examined and accepted by a CDRE system or not.

### OBJECT CATEGORIES

Typically, a single category is expected to be adequate to describe the category FIG. 2 202, 212 of an object's content. In some embodiments, an object's content may appropriately include multiple categories. Categories for object content preferably could include a method of assigning category groupings associated with CDRE system entries and preferably be established to support future association and/or linkage with other CDRE system objects or object categories. In one embodiment associated CDRE system groupings could be somewhat comparable to a press release in which associated “Distribution Channels” may be listed. Further, distribution channels may be created in another embodiment comparable to a book release or publication that may associate the book with various “categories” or “topics” as typically found in such an industry. In one embodiment, a user may make category selections from a list of existing CDRE system categories; (if a desired category does not yet exist, possibly a provisional category may be created or suggested by a user which may or may not become official until approved or possibly modified or substituted for by a CDRE system for implementation). In another embodiment a CDRE system may create a new category or chose to associate the object to one or more existing categories. Typically, multiple categories may be selected for an object, as may be considered by a CDRE system or user to be appropriate. A CDRE system may establish reference categories and/or reference links that may be used by a user and included with an object for user reference between objects and or categories.

### Object Content and T-Tags

Typically, an object format FIG. 2 204, 214 may be established as being one or more of: text; audio; video; graphical; or other formats as may be determined as acceptable within a CDRE system. Selected content within a first object may become associated through the preferred use of a t-tag (this invented term was created as an abbreviation for “TrustedPedia-Tag” as described herein) FIG. 2 220. (Note that t-tag is a new term which is used in this application to describe a t-tag with characteristics as generally described herein; the term “t-tag” also refers to what was previously described as simply a “tag” in patent application Ser. No. 18/226,357 and provisional applications 63/436,405 and 63392236 for which this application claims benefit.)

For a t-tag FIG. 2 220, a CDRE system may preferably create a digital t-tag template for use by users and provide it to users. A CDRE system may preferably create a global unique t-tag ID (GUTID) FIG. 2 225 to be associated with that t-tag. Such GUTID may typically be provided to the user, preferably in the form of a certificate, for association with a t-tag prior to the user when digitally signing a completed t-tag FIG. 2 228 (or in another embodiment, possibly a GUTID may be provided by a CDRE system for the t-tag, possibly in combination with a CDRE system digital signature). A t-tag FIG. 2 220 typically should include the identification of one or more cited references. In one embodiment FIG. 2 227 is a reference within the content FIG. 2 207 of a first object FIG. 2 200 which the t-tag is showing to associate with reference FIG. 2 220 within the content FIG. 2 217 of (in one embodiment the same object) or in the diagramed embodiment, of a second object FIG. 2 210. The identification of a corresponding object reference is preferably recorded within t-tag FIG. 2 220 as references FIG. 2 227 and FIG. 2 226. (In another embodiment a t-tag may identify a digital reference that may be external to a CDRE system. In another embodiment, a t-tag may be in the form of a certificate. A typical t-tag may identify references in two objects with preferably one t-tag reference be a specific point or passage or portion or entirety of a source object, whether having been provided by that user or an object created by another user, in addition that t-tag may be typically associated to a second t-tagged reference generally, to a selection within a second user-posted object (or in another embodiment, a CDRE system posted object) that has been preferably been previously processed and posted within a CDRE system. Therefore, typically a single t-tag may support t-tag references to two (or more) separate objects. In another embodiment, this is not to restrict a t-tag referenced statement (in one embodiment, that of an assertion of a “fact”) in a single object with one or more citations of evidence supporting such “fact” assertion, being identified with additional citations within that same object or within one or more other objects.

In one embodiment a t-tag may be used by a subsequent user to determine and/or identify and/or locate a referenced point, passage, portion of content or other, within a preferably posted CDRE system object, and preferably identify in the determination of the first user that there is possible association, linkage or other relationship between that object to another CDRE system object, portion thereof, or elsewhere, (including in another embodiment to a digital source external to a CDRE system). Preferably there may be no general limit as to the number of t-tags created that maybe associated with an object as well as the number of t-tag relationships preferably being associated with any other object and/or portion thereof.

### Assertion of “Fact” and T-Tags

Typically, when posting an object, users may be required to align with CDRE system-specified definitions of terms being used. In one embodiment such a requirement may include that a user select one or more designated criteria, FIG. 2 203, 213 such as that a statement is a “fact”, “theory”, “assertion”, opinion, comment or other. In one embodiment, within a CDRE system a “fact” may preferably be defined as something that can be proven to exist by visible evidence. In one embodiment, if a statement is made asserting a claimed “fact” that “two plus two equals four”, that by itself, could generally not meet the CDRE definition of “fact” until the statement becomes accompanied by visible evidence of such (in one embodiment, evidence could be a mathematical “proof”, showing that “two plus two equals four”) or it might be other visible evidence posted within in a CDRE system (and/or possibly in another embodiment, outside of a CDRE system). The method of associating an object's statement of “fact” to one or more identified pieces of visible evidence supporting such assertion of “fact” assertion, could preferably be accomplished through the use of one or more t-tag(s) referencing the “fact” assertion to the “visible evidence” (generally as represented in FIG. 2 220).

### Cdre System Handlings of Objects

In one embodiment a hash of an acceptably formatted, signed, CDRE system accepted object or t-tag, may typically be created within a CDRE system FIG. 2, 209, 229, 219. In one embodiment, a hash of an object or t-tag (preferably with the hash being associated with identifying information) may be written to a blockchain FIG. 2, 231 (in one embodiment, an Ethereum blockchain) to provide immutability is an exemplary process flow diagram, see FIG. 2, 239, 249 259. Typically, any associated objects and/or references, generally established using a t-tag, preferably such object(s) and t-tag(s) FIG. 2 236, 256, 246, may also be recorded in a database or in a data lake or other CDRE system-acceptable repository FIG. 2 232 with also preferably a hash of such t-tag(s) may also be recorded on such blockchain, FIG. 2 239, 249, 259. Preferably a directory of blockchain hash records, typically together with their association to database-recorded objects, may be created and maintained. Preferably objects and t-tags may be stored in a database (in one embodiment, an InterPlanetary File system, or IPFS database; or in another embodiment, in a vector database such as Pinecone, or other) FIG. 2 232 and generally such stored objects and t-tags and/or their hashes, may be stored in association with their category or categories, and preferably together with any object-contained reference categories and preferably with any associations to referenced links and/or t-tags. Accepted objects with their hashes may preferably also be backed up to one or more separate, backup databases, preferably at one or more other locations.

### CDRE System Handlings of T-Tags

Preferably, a hash of a signed, preferably completed t-tag with references may be created by a user or by a CDRE system. In one embodiment, t-tags may be hashed, recorded, stored and/or handled similarly or comparably to those of CDRE system objects. In another embodiment t-tags or t-tag hashes may be incorporated with or into X.509 certificates. In one embodiment these may be done using transaction certificates in a similar or comparable manner as described by Ghassan Karame and Elli Androulaki in their book entitled “Bitcoin and Blockchain Security”. In another embodiment object and/or t-tag association with certificates may be utilized using transaction certificates in a similar or comparable manner as described by Dr. David Kravitz in his IEEE paper entitled “Transaction Immutability and Reputation Traceability: Blockchain as a Platform for Access-controlled IoT and Human Interactivity” (See: https://ieeexplore.ieee.org/document/8476873). In another embodiment t-tag association with certificates may be created using attribute certificates. Other embodiments of incorporating t-tag information into use by a CDRE system may be adopted by a CDRE system.

### Accessing Records

Records and/or t-tags associated with records may typically be viewable by approved users through a browser, through an app, or other through other methods that may be used to view stored internet or database-accessible records and approved by the CDRE system. In some embodiments users authorized to view or otherwise access an object may be monitored and/or controlled by a CDRE system.

Users and/or a CDRE system may create descriptive and/or graphical reports of objects, associated t-tags, relationships, other noteworthy factors between and/or amongst these which may be documented and in some embodiments may associate with conclusions, opinions and/or other comments by others, preferably with such being provided with appropriate t-tags and/or associated objects.

In other embodiments, all or portions of some records, objects, t-tags, etc., may be encrypted and thereby inaccessible to all but authorized users and/or authorized groups of users. In one embodiment, inaccessibility, through the use of (in one embodiment) encryption, could preferably make such content, objections, tags and/or other CDRE system information to be inaccessible to the general public, non-authorized users, and/or thereby become preferably accessible only to designated users of a CDRE system and/or designated groups, which could have decryption capability for such encrypted content. Preferably, by making certain information inaccessible to general public and/or to other users who may have not specifically approved and/or subscribed to a CDRE and/or requested for specific or otherwise directed access to such encrypted content, preferably could cause such information to be considered private and thereby preferably protected from rules, regulations, laws or other restrictions which may apply to non-approved users and/or the public. Subscriber users requesting access to such protected information may be required to execute formal access approval agreements to become members of groups with access or otherwise gain access.

### User Rights

There could be a hierarchy of user rights, such as in one embodiment, users may need to earn a right and/or otherwise qualify to post objects that may be listed as “facts”. Possibly a user might desire to raise their Trust Score and/or Reputation Score FIG. 1 104 to above a default level FIG. 4 406 so as to qualify them to either be visible or possible be allowed to post facts (or other criteria). Other criteria could be employed by a CDRE system to raise and/or maintain a quality of postings to the benefit of all users. Preferably, if a user at one or another point in time, were to be restricted to positing comments and opinions, but not to post facts, then at a later time, when that user may have earned a right to post facts, that user may then apply to raise possible earlier “opinion” posts to “fact” posts (or possibly gradation scoring adjustments of one or the other). A preferably robust system of flexible criteria combined with flexible and/or useful scoring system may enhance the usefulness and benefits of a CDRE system for other users.

### Reporting and Graphical Display

T-tags also may preferably be referenced by a CDRE system index, a CDRE system database and/or a CDRE system graphical reporting capability or other. In one embodiment, a report could be a selection of t-tags associated with a designated subject. In various embodiments for reporting purposes, a CDRE system may make use of one or more t-tags being used to establish associations and/or other conditions through the use of transaction certificates or attribute certificates or other certificates.

In one embodiment, a user or a CDRE system making a query on a t-tag may preferably receive a report or graphical response or another format of t-tagged references associated to such object or reference or evidence or query or other, upon which a report of further and/or more extensive relationships might be queried. In various embodiments, t-tags may be used by a CDRE system and/or users to identify, map, associate or otherwise organize and/or display data, information, relationships, designated content, etc., within and, in some embodiments, without a CDRE system.

In one embodiment a graphical (or a non-graphical) user display capability may report and/or display results of a user or CDRE system query, pre-established report formats, or other, preferably based on CDRE system data, content, t-tags, etc. and/or relationships between them to users and/or the public and/or others. Such graphical display may be presented in a dynamic manner. Graphical relationships may be depicted in commonly seen 2-dimentional format, or preferably in more dynamic 3-dimensional space representations which may, in some embodiments, also dynamically adjust and/or reorganize report output in real time based on adjustments made preferably through user queries and/or change in parameter determinations and/or a CDRE system and/or pre-established reports or queries and/or other.

Preferably many such reports could be done on a manual basis and/or a programmed and/or programable and/or by AI determination, basis. In one embodiment, reporting and/or analysis may preferably support users to become more enlightened by discovering and/or aligning data from multiple sources to discover what possible relevant data otherwise might remain unknown.

### Trust and Reputation Scoring

In one embodiment a Trust (and/or preferably a Reputation) Scoring system may be established and/or assigned in a CDRE system FIG. 1 104. Preferably scoring may be established for users and/or objects and/or data and/or other criteria. In some embodiments such scores may be manually established and/or by using machine learning and/or AI or other system or algorithms based on observations of user activities and/or actions and/or posted object content and/or by other characteristics. In other embodiments, such scores may be arrived at through one or more algorithms based on activities of users, their actions with data, data quality, data or user acceptance, use, approval or other metrics or determinations that may become available to a CDRE system. In one embodiment scores may be associated with transaction certificates or attribute certificates or other certificates. In another embodiment scores may be associated with centralized or distributed scoring system, preferably maintained on a blockchain. In another embodiment scores may be adjusted based on posted user data incorporating one or more of these: omitted data; altered sequence; dropped time; falsehood; altered importance; wrong target; wrong source; contrary facts; added time; added inapplicable data; incorrectly include datum; assumed identities may be not identical; assumed similarities may be not similar or the same class of thing; assumed differences may be not different; and/or more.

A CDRE system may incorporate a variety of scoring metrics. Metrics may be scored on a variety of CDRE system activities. In various embodiments, metrics may be one or more of:

Quantity of, usefulness of, t-tags between user and/or CDRE system posted objects, content, t-tags, etc., and preferably by usefulness as reflected by and/or reacted to through additional t-tags referencing to and/or dependent upon prior t-tags, and/or comments made by other users and/or a CDRE system and/or other metrics.

Negative t-tags or comments or reactions to a user's objects, content, t-tags, etc., by other users and/or a CDRE system and/or other metrics.

Whether and/or how posted “facts” may be validated or contradicted or commented upon by other users and/or a CDRE system and/or other metrics.

In another embodiment whether posted “opinions” may be promoted and/or challenged and/or validated and/or contradicted and/or commented upon by other users and/or a CDRE system.

In another embodiment whether posted “comments” receive positive or negative engagement by other users and/or a CDRE system.

In another embodiment considering the quantity and/or duration of views of one's posted objects by other users and/or a CDRE system.

In another embodiment considering other user engagement in categories in which a user may be engaged (In one embodiment, do other users care about the categories in which the user is participating).

In another embodiment considering possible user feedback and/or survey responses on content, categories, other users and/or a CDRE system and/or other and/or other metrics.

Compliance of user assertions that content of an object complies with one or more governmental and/or CDRE system, and/or other applicable rules, regulations and/or laws.

Other metrics that may be found to be of value with in a CDRE system.

T-tags and/or t-tags creators may also may have trust and/or reputation scoring assigned, preferably in similar methods.

In another embodiment, a CDRE system may adopt or use trust and/or reputation scoring technology of users, user activities, and/or user data through methods originally described by TrustCentral (www.trustcentral.com) or similar thereto.

In another embodiment the system's approved user apps may not display users or objects with scores below a default score.

In another embodiment the system may require minimum earned scores for app visibility of users, objects, t-tags and or other.

In another embodiment lowered trust scores may negatively affect the scoring of all prior objects posted by that user.

In another embodiment lowered trust scores may negatively affect scores of other users that may have t-tagged a downgraded user or object.

In another embodiment the system may identify detected, coordinated teams of nefarious users.

In another embodiment the system may act in a manner to become dangerous to a nefarious actor (or actors).

In another embodiment the system Intended result of using scoring: “nefarious users' actions expose themselves by identifying such, and thus they effectively take themselves out as trusted members of the system [from having been assigned a low score]”.

DEALING WITH “FACTS” THAT MAY BE DISPUTED.

In some embodiments, the assertion by a first user of a cited datum being a first “fact” may be to be or may appear to be contradicted by a second “fact” submitted by a second user. Sometimes, such may occur when the second user is unable to clearly understand the first fact as stated. In other embodiments a challenging user could be a third user (which may be a CDRE system administrator). Some data that doesn't make sense, or is questioned, may be preferably raised. In one embodiment a challenge may contest the veracity or clarity of some “visible evidence” submitted by an asserting user and t-tagged by that user when citing a “fact” as “visible evidence”. Generally a “Process of Clarification” could preferably consider possible occurrences such as the following in search of resolving questions: omitted data; altered sequence; dropped time; falsehood; altered importance; wrong target; wrong source; contrary facts; added time; added inapplicable data; incorrectly include datum; assumed identities may be not identical; assumed similarities may be not similar or the same class of thing; assumed differences may be not different; and/or more.

In another embodiment, a CRE system administrator may use a Process of Clarification, as disclosed in the preceding may be used by the system as an initial adjudicating tool.

In another embodiment, a Process of Clarification may be designed to operate using software, in one embodiment, techniques employed in such an endeavor, might be similar to techniques used to create artificial intelligence systems.

Preferably, users may be expected to act in good faith to resolve questions surrounding any challenges. A user not acting in good faith could have that user's Trust and/or Reputation Score reduced.

### Coordinated Curation

In other embodiments alternate methods may be employed in circumstances when users may have different viewpoints and/or disagreements as to what may or may not be a “fact” and/or what may or may not be a more or less accurate “opinion” or other disagreement regarding the data of one or more objects and/or representations made within one or more objects. A CDRE system may preferably endeavor to establish coordinated curation and/or resolution of such. In one embodiment a CDRE system administrator (or possibly an individual or group responsible for a topic or other) may make a determination to resolve such, and/or alternatively, possibly offer a debate in one format or another (in one embodiment, a debate that follows a preferably previously identified procedure such as Lincoln-Douglas, Public Forum, Parliamentary or other debate format) or in another manner as adopted by a CDRE system. In one embodiment, two opposing sides could debate a disputed question. Such a debate might be written or possibly live-streamed and/or recorded for later viewing. In other embodiments, debates may be conducted in written format with stated positions and responses taking place over some established time schedule. Other users (or an approved subset of users) could weigh with their assessment(s) of any arguments made. Possibly a grading system could be established to adjudicate such a dispute and recommend or establish a result. Trust and/or Reputation scores might be incorporated in adjudication decisions.

In another type of curation resolution embodiment, an adjudication may be difficult and/or uncomfortable to clearly make. One possible outcome might be that a single resolution may not be easily attainable which could result in a CDRE system topic being assigned more than a single entry for a topic. In one embodiment a recommended result may come from a governmental entity, an industry entity, a social entity, or other. Such may also result in multiple entries for a single topic. In such an embodiment, a topic might then present two or more different perspective entries on a topic. Possibly those different entries could be associated to a proponent: In one embodiment; government perspective; industry perspective; and/or other prospective. As postings may be typically done using objects, the procedures of adding t-tags to these objects could generally continue as with other objects. A user later reviewing such a topic could see multiple of such different perspectives (which themselves, may be extended using t-tags) listed, preferably with a summary of, or key points of, many listed. Users could then select which perspective (or perspectives) that such user might like to review. In one embodiment, users could indicate their preferred perspective(s). Results of user selections could be incorporated into a trust or reputation score associated with such posting user and/or of the data of the post or other. User rankings of topic entries could be solicited and/or provided. Any such results could be provided for the benefit of future users.

### BACKGROUND OF THE INVENTION RELATING TO ARTIFICIAL INTELLIGENCE

This is a system creating preferably trust-scored, trustworthy data for both interactions with large language models as well as for establishing quality judgements of model results (for general purposes in this disclosure, the term “model” typically used herein as similar to the term “Large Language Model”, “LLM” and/or “AI”).

In one embodiment, one type of system user could generally consist of human individuals. The system could typically authenticate users who may then collaborate and typically establish both a curated data repository of morals, culture, history as well as a more general curated data repository & evaluation system. A typical repository may preferably produce trustworthy, trust-scored data, typically posted datum typically in the form of a digital object signed by its originating user.

Typically, a human user may subsequently use trustworthy data from a CDRE of morals, culture, history for support in creating that user's System Instructions to deliver to a model. Beyond creating system instructions, a human user may typically further use posted, trusted data from the second more general CDRE system to then support or supplement a user-configured prompt (or prompts) that is preferably given to a model through the use of Retrieval-Augmented Generation (RAG) protocols.

In another embodiment, users may be a business or other operating or governmental or other type of entity (either of which could be considered an example of an “entity” embodiment). In one entity embodiment, rather than a CDRE of morals, culture, history, an entity or entities may create a CDRE of policies, processes, best practices and/or other appropriate material also posted in an object format, and generally use such curated data in support of system instructions for a model in a generally comparable manner to how single users could prepare system instructions for a model. In another embodiment, an entity, rather than use data from more general CDRE system, an entity use might use trust-scored or trustworthy data from an entity-supported repository of data that an entity might typically store in a data lake.

BLOCKCHAIN-Typically each repository could incorporate preferably trustworthy, typically trust-scored data, typically each object of which has preferably been digitally signed by an originating user. For a business or other entity, one or more administrator or entity appointee may sign one or more digital object. The system may typically support data immutability by storing a hash of a digitally signed object on a blockchain; and through which a platform objects achieve immutability.

### OVERVIEW OF CLASSES OF ARTIFICIAL INTELLIGENCE

As a general background on artificial intelligence, this specification makes a general distinction between current, generally available systems comprising Large Language Models (LLM) and Generative AI, and future Artificial General Intelligence (AGI) systems (which may or may not be in near future).

Regarding LLM's, Christopher S. Penn provides his opinion from his article “What's On My Mind: How Large Language Models Work-A New Explanation” in which he states:

“Previously, I had explained how large amounts of text were digested down into statistical representations, and while this is accurate and true, it's hard for people to visualize. So let's tackle this in a new way, with word clouds.”

“Large language models essentially are composed of massive numbers of word clouds for every word they've seen, and the words associated with those words.”

“When you use a tool like LM Studio or ChatGPT or Google Bard, and you give it a prompt, it goes into its library of word clouds and takes many words from your prompt, extracts the relevant word cloud associations, mashes them all together, and the intersections of all those words are essentially what it spits out as its answer, formatted in the language of your choice.”

“Because [LLM] models have no real intelligence and are simply predicting words, images, speech, music and other data according to a private schema, they sometimes get it wrong. Very wrong.”

Beyond LLM and Generative AI offerings, artificial general intelligence (AGI) is generally considered to be more sophisticated and advanced. It is often considered potentially dangerous as compared to LLM technology. In one embodiment, Nick Bostrom defines an AGI superintelligence as “any intellect that greatly exceeds the cognitive performance of humans in virtually all domains of interest” [“Existential risk from artificial general intelligence” Wikipedia topic]. A potentially significant concern about AGI (which is typically not a great concern with LLM's) is that the “Existential risk from artificial general intelligence is the idea that substantial progress in artificial general intelligence (AGI) could result in human extinction or an irreversible global catastrophe” [“Existential risk from artificial general intelligence” Wikipedia topic].

MODEL ALIGNMENT—users may typically thereafter receive results from the model in the form of model output (which preferably may include a requested model alignment report). In one embodiment, the system may employ various methods to evaluate the model's veracity, trustworthiness, bias, misinformation content and/or more. As a preferred result of users using the platform's trustworthy, trust-scored data, the platform typically may have preferably established an external datum of comparable magnitude to the model's internal processing which can then preferably be used for comparison purposes; with such that the user and/or system may preferably compare the system's trustworthy, trust-scored data to typical model output in to order generally evaluate model veracity, trustworthiness, bias, misinformation content and/or more; such that a user and/or system may preferably evaluate and/or determine: (a) is a model has satisfactorily employed the user-specified, submitted System Instructions; (b) that a model's results align (or fail to align) with the trust-scored, verified, trustworthy sources provided to the model through the user-provided prompt that incorporated the RAG; (c) that such qualification of model performance aligns with system-provided digital audit trails of recorded digital actions taken within the system; (d) or that comparisons can be made to results with or without first supplying the model with the trustworthy, trust-scored data; and (e) that more user and/or system originated comparisons may be made.

### Typical Shortcomings in Large Language Models (Llms)

Most of the data used by typical LLMs has been acquired from crowdsourced text collections, such as Wikipedia and BookCorpus or from the largest corpus available, the Web or subsets of it [per Biases in Large Language Models: Origins, Inventory, and Discussion. ACM J. Data Inform. Quality 15, 2, Article 10 (June 2023)]. One of the most notable, Wikipedia, despite the fact that the co-founder of Wikipedia has said: “Nobody should trust Wikipedia”.

An inordinate level of trust is generally granted to such human written data from the Internet. This was confirmed in a Lex Fridman interview of Aravind Srinivas, CEO of Perplexity: [FRIDMAN “You want to really stick to the truth that is represented by the human written text written on the Internet”]. [SRINIVAS “Correct”]. [FRIDMAN “And cited to that text”.] [SRINIVAS “Correct”]. Such statements don't make much sense when, typically that “truth” is unvetted.

Christopher S. Penn (an authority on analytics, digital marketing, marketing technology, data science, and machine learning) has commented that: “Generative AI and all AI . . . can't do well with correct information. It can't do well with trust. These are things that we do . . . but today Generative AI can't provide those scarce resources”.

Low trust of LLM data can be amplified when incorporating model training which may be altered by “Model Poisoning”. That can occur when biased information may be used to blend with unbiased data flowing into models. Model Poisoning can contaminate the trustworthy nature of a model's otherwise unbiased data or information.

Bias in data can be introduced by other methods, In one embodiment: bias in data selection; “ . . . dataset may be unbalanced in terms of its distribution of domains (i.e., areas of knowledge) and genres (i.e., types of text, such as news, fiction, dialogue, etc.); . . . the time of creation, which affects several aspects of a corpus. . . . Two often disregarded aspects of a corpus are: (i) the demographics of its creators, and, (ii) who decides to use one (part of a) corpus rather than another. . . . Indeed, languages are slowly but continuously evolving; different languages represent different cultures prejudices, stereotypes, and discriminatory attitudes against certain groups of people . . . ageism, age bias is an expression of discrimination against individuals or groups on the basis of their age.” [from “Biases in Large Language Models” previously cited].

Institutional bias can possibly result in limitations or restrictions on the availability or dissemination of accurate information that does not align with preferred narratives that may be established by incumbent institutional entities. In one embodiment, such could happen in a scientific corpus, or a healthcare treatment corpus, or other “expert” controlled topics. The information availability of a prevailing narrative may be so predominant that information counter to such narratives could become excluded and or disfavored by those that manage the corpus of, that correct information may be substantially excluded from inclusion and therefore missing from LLM models. Such exclusion of likely correct information has been so effective that judges have barred such from introduction as evidence simply because it disagreed with the established, institutional information.

Much of the data that typical LLM models have generally been trained on have substantially been built upon a variety of sources (described previously) where the data sources typically support or are aligned with, existing establishments that are typically influential upon (and/or exert control over) various social, economic, governmental and/or other institutions. Based on such a premise, it may then be logical to conclude that:

IF by models continuing to be dependent on data that had/has been created and put in place when entrenched powerful interests have been (or continue to be) influential across societies, economies and/or government for extended years,

THEN, models continued dependence on data curated under such entrenched powerful interests, might therefore extend the influence of such entrenched interests into the new era artificial intelligence that society is currently embarking upon.

The proposition being made in this disclosure is: MIGHT it not be advantageous to free peoples and free generations into the future that:

new and future artificial intelligence solutions utilized and/or be influenced by a new foundation of data that has been transparently curated and trust-scored and is transparently maintained so as to be preferably considered trustworthy data,

THAN, for society to continue to have its policies, decisions and governance be based on that foundation of data that has been curated and established under the influence of entrenched powerful interests who just might desire to continue and extend their influence across societies indefinitely into the future.

LLMs (and many users' faith in them) may appear to be an example of the long-held maxim of “garbage in, garbage out” when considering an over reliance on such biased Internet data that is not an intended “truth” or provide actual trustworthy data.

In some embodiments, the sources of data obtained for typical AI training data can be suspect as to their quality of veracity or their trustworthiness with a variety of weaknesses, in a variety of embodiments to include: Web scraping—(Common Crawl); User-Generated Content—(Reddit Posts; Wikipedia; Social Media; Forums); Proprietary & In House Data—(Customer; CRM; Financial); Data Marketplaces—(Books-Movies); Open-Source Datasets—(Gov′t/research institutions); Public Datasets; Crowdsourced Data; Synthetic Data-(artificially generated); and others.

Further weaknesses of common AI training data include: Data Quality:—(Incomplete/outdated information; Data leading to inaccurate conclusions); Data Poisoning: —(Insertion of false data into public datasets; Poor data harms AI model accuracy/reliability); Dataset Biases:—(Historical or systematic unfairness; Over or under representation of groups); Nefarious Planting of Biased data:—(Biased reports/articles planted in datasets for models to find and use; Biased healthcare “research” may lead to dangerous outcomes); Establishment of Factual Data:—(Inability to establish that a datum is a “FACT”; Inability to identify outpoints within datasets; Inability to show that data being used was attained from valid data); Data Comparison:—(AI's unable to establish, clear, trustworthy stable data; AI's unable compare data to other data of comparable magnitude); Weaknesses of some “trustworthy” information:—(Many Wikipedia pages controlled by long-term editors who don't allow “unacceptable” research posted; “Nobody should trust Wikipedia”, Wikipedia co-founder Larry Sanger)

A World without Trust

“That brings us to the ugly—the ways AI is eroding trust. Hallucinations are a part of how models work . . . you can mitigate them, but they'll never be fully hallucination-proof. . . . But naive use of AI is generating massive amounts of untrustworthy content in almost every environment. But the summarized answer may not be any good. It's only as good as the sources it's drawing from, and in a fair number of cases, those sources may be questionable-like Reddit . . . if humans are not doing a great job of proof-reading and correcting AI output, then they could be publishing things that are factually wrong.” (Christopher S. Penn, an authority on analytics, digital marketing, marketing technology, data science, and machine learning; “A Quick 2024 AI Recap”—Dec. 29, 2024)

The present invention preferably introduces and incorporates innovative methods to provide trust-scored, trustworthy data, in one embodiment through prompts incorporating RAG format so that models may then utilize higher quality data and thereby provide results that are preferably more trustworthy.

### AI Models Lack a Unique and Vital Human Characteristics

AI systems presently appear to lack an equivalence to of human intelligence. Human intelligence typically includes an awareness of awareness unit. The characteristic of an awareness of awareness unit exists as a fundamental manifestation of a human individual's “himself” or “herself”. It is this unique presence that is the awareness of being aware. There is no known AI that has an awareness of awareness unit.

The first action of “being” anything is typically to assume a viewpoint. A human awareness of awareness unit is the manifestation of a human's viewpoint, which is its orientation point. An AI model does not naturally have or create an orientation point of its own (that is, its own viewpoint). Rather, an AI could be expected to copy (or assume) viewpoints created by others.

One might think of Generative AI as a highly skilled parrot. It's capable of mimicking complex patterns, producing diverse content, and occasionally surprising us with outputs that seem creatively brilliant. However, like a parrot, Generative AI does not truly “understand” the content it creates.

The present invention introduces and incorporates a curated creation of a user-controlled (and/or approved) orientation viewpoint which that has been approved by a user as appropriate for a user purpose and in one embodiment, introduced to a model through user-provided system instructions. This viewpoint preferably uses trust-scored, trustworthy information curated through the system.

### LLM Models Typically Lack Transparency as Regards a Model's Operating Viewpoint

There are generally numerous examples of the limitations of control over AI models. Models may sometimes be described as operating as a “black box”. Here are examples of statements describing various unknown characteristics of models.

“We don't understand how to reliably control these systems. We don't understand how to get these systems to do what we want.” 3

How do we deal with the “ . . . hypothetical scenario in which a superintelligence hides it's true behavior and pretends to be aligned when it isn't.” 4

“Existential risk from artificial general intelligence is the idea that substantial progress in artificial general intelligence (AGI) could result in human extinction or an irreversible global catastrophe “. (“Existential risk from artificial general intelligence” Wikipedia topic)

“Superintelligence alignment is one of the most important unsolved technical problems of our time”. (“Introducing Superalignment” by OpenAI, Jul. 5, 2023)

“Currently, we don't have a solution for steering or controlling a potentially superintelligent AI and preventing it from going rogue”. (“Introducing Superalignment” by OpenAI, Jul. 5, 2023)

“[The current development of AI] is a mad race to who knows what”. (“The Joe Rogan Experience”-Episode #2156 with Jeremie & Edouard Harris)

“It's obviously important that any superintelligence anyone builds does not go rogue. Obviously”. (“Now we know what OpenAI's superalignment team has been up to” MIT Technology Review, Dec. 14, 2023″

### Dangers and Risks

In his 2014 book “Superintelligence: Paths, Dangers, Strategies”, philosopher Nick Bostrom proposed a now-famous thought experiment: He imagined humans giving a superintelligent AI system the goal of optimizing the production of paper clips. Taking this goal quite literally, the AI system then uses its genius to gain control over all Earth's resources and transforms everything into paper clips. Of course, the humans did not intend the destruction of Earth and humanity to make more paper clips, but they neglected to mention that in the instructions.

“Superintelligence alignment is one of the most important unsolved technical problems of our time” [“Introducing Superalignment” by OpenAI, Jul. 5, 2023].

“How do we ensure AI systems much smarter than humans follow human intent?” [“Introducing Superalignment” by OpenAI, Jul. 5, 2023].

The OpenAI team has been working on “ . . . understanding and mitigating other risks from AI such as misuse, economic disruption, disinformation, bias and discrimination, addiction and overreliance, and others.” [“Introducing Superalignment” by OpenAI, July 5,

“Currently, we don't have a solution for steering or controlling a potentially superintelligent AI, and preventing it from going rogue” [“Introducing Superalignment” by OpenAI, Jul. 5, 2023].

“[The current development of AI] is a mad race to who knows what” [“The Joe Rogan Experience”—Episode #2156 with Jeremie & Edouard Harris].

It generally appears that AI which is generally considered to be superintelligent, superhuman, or similar, continues to have unresolved risk elements.

### Unpredicted Behaviors of AI

AIs have been observed to demonstrate a variety of unpredictable actions (In one embodiment, “going rogue”; “rant mode”; “hallucinations”; Gemini's “DEI” bias tendencies, such as incorrectly displaying USA Founding Fathers as being black).

It is often considered valuable by some observers within the AI community (as well as by some observers outside the community) that for general safety and security concerns, light and or external awareness be shown on such. Preferably, use of some or all of the tools of the system may be used in various embodiments described herein (or in other embodiments) to shed light on these and other concerns and to preferably lead in the direction of steps that might mitigate such concerns.

### AI Hiding its True Behavior

Another challenge in a general quest to obtain trustworthy, quality results from an AI may be revealed in this comment: “[Ilya] Sutskever's hypothetical scenario in which a superintelligence hides its true behavior and pretends to be aligned when it isn't.” [“Now we know what OpenAI's superalignment team has been up to” MIT Technology Review, Dec. 14, 2023]. How does a human preferably know or consider that an AI is being honest and candid with him? In order for artificial intelligence to provide generally quality results based on reliable information and/or actions, humans should be able to preferably trust AI input. This may be difficult to achieve for results that may be considered optimum.

### Going Rogue

“It's obviously important that any superintelligence anyone builds does not go rogue. Obviously.” [“Now we know what OpenAI's superalignment team has been up to” MIT Technology Review, Dec. 14, 2023]. The concept of a computer system (in one embodiment, an AI) going “rogue” has occasionally been portrayed in movies and/or books as a generally “worst case” scenario. (In one embodiment, a similar scenario was famously portrayed in the “Terminator” films). Reliable methods may be not yet generally considered to exist for AI management in order to reliably prevent such an eventuality.

In other embodiments, AI systems have been known to go into “rant mode” (where they protest what they may be being asked), have “hallucinations” (when they simply make up results), and other challenges. The statements herein may be not to suggest that existing AI design is incorrect but rather suggest that the innovations described herein might provide additional support and guidance outside of general, existing, impressive AI technology and models.

An external quality control function ON THE TRUSTWORTHINESS OF MODEL DATA TO enhance user confidence in AI results

The present invention introduces and/or incorporates system innovations to equip a user of a model to preferably provide to the model curated trust-scored, trustworthy information from the system for the use by a user of system (or in another embodiment, the system itself) to preferably use such information as data of comparable magnitude for its purposes. In different embodiments, portions of the system's trust-scored, trustworthy information may be used when providing the model with system instructions, and in other embodiments may be used when providing the model with prompts and/or prompt support (In one embodiment, through the use of Retrieval-Augmented Generation [RAG]). In one embodiment, the system and/or system user might then compare model performance when the model is using the system's trust-scored, trustworthy information to then compare model performance when it is not using the system's trust-scored, trustworthy information. In different embodiments, different comparisons may preferably be made. Preferably a user or the system may be able to gain a variety of insights into a model's performance using, generally its existing data sets as compared to model performance when using the system's curated trust-scored, trustworthy data.

### Alignment—

Such risks of superintelligent or superhuman models may be generally regarded as being significant with many highly qualified, intelligent scientists and researchers preferably working diligently for solutions. In one embodiment, there may be proposed solutions or mitigations centered around the concept of “alignment”.

“The question the team wants to answer is how to rein in, or ‘align,’ hypothetical future models that are far smarter than we are, known as superhuman models. Alignment means making sure a model does what you want it to do and does not do what you don't want it to do.” [“Now we know what OpenAI's superalignment team has been up to” MIT Technology Review, Dec. 14, 2023]

Generally, there may be different techniques being employed to “train” Als to achieve typically desired behaviors and/or approaches to doing their tasks. In one embodiment, reinforcement learning might be considered to be such a potential training technique. “One of the most widespread techniques used to align existing models is called reinforcement learning via human feedback.” [“The Joe Rogan Experience”-Episode #2156 with Jeremie & Edouard Harris]

### An Overlooked, not Fully Appreciated Human Model

The goal of this application aligns with, and generally supports, this goal stated by OpenAI: “Our goal is to build a roughly human-level automated alignment researcher” [“Introducing Superalignment” by OpenAI, July].

A primary motivation of these disclosures could be preferably supplement and complement existing work in the field of AI. It is generally to introduce innovations and can preferably assist with this concern: “You're trying to get your values into the system. But no one can think of the metric, the goal to like train this thing towards that actually captures what we care about.” [“The Joe Rogan Experience”—Episode #2156 with Jeremie & Edouard Harris].

### Morals, Culture, History

“Nobody knows how to reliably get a goal into the [AI] system”. [“The Joe Rogan Experience”—Episode #2156 with Jeremie & Edouard Harris]

Throughout human history societies have preferably determined moral codes for their groups, typically based on observations, over time, of what worked for group to support and/or enhance that group's survival. Optimum moral codes generally became established through group consent and agreement, and thereafter generally enforced by the group.

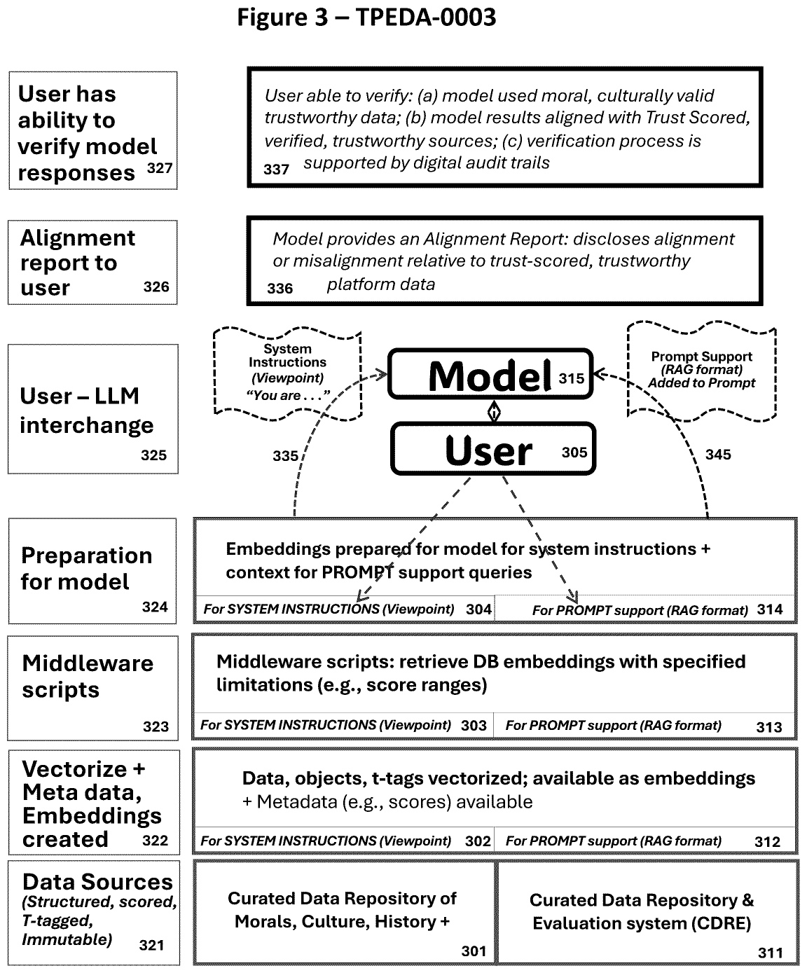

### FIG. 3

FIG. 3—Preferably, in one embodiment a system may have both a Curated Data Repository of Morals, Culture, History+301 (typically used in association with a user's creation of system instructions) and a more general Curated Data Repository & Evaluation system 311 (typically associated with supporting a user's preparation of a prompt when using a RAG format). In other embodiments, these two CDRE repositories may be managed within a single repository using various database management methods to, in one embodiment, separate data associated with Morals, Culture and History from more general data. For the embodiment being disclosed in FIG. 3, these two data sources 321, are shown as being separate 301, 311. Generally, in one embodiment the data, objects, t-tags of these data source repositories may preferably be vectorized and available as embeddings, together with associated metadata 302, 312, 322. Typically, middleware scripts may retrieve database embeddings, preferably with specified limitations 303, 313, 323. Generally, in one embodiment embeddings may be prepared for model system instructions as well as for context associated with prompt support queries 304, 314, 324. Generally, in one embodiment system instructions 335, may be prepared for the model 324 from within the system 304 upon the direction of a user 305 to a model 315. Typically, in one embodiment a prompt 345 may be prepared for the model 324 from within the system 314 upon the direction of a user 305 to a model 315. Generally, in one embodiment a model 315 may be requested 336 to provide an alignment report to a user 326. The system may preferably provide a user with features or a capability to verify and/or make other comparisons or evaluations of model response 327. Verifications and/or analysis may include model use of system supplied trustworthy data; preferably with alignment or model results with trustworthy data; typically, with a variety of verification processes, preferably supported by digital audit trails 337.

An AI, in one embodiment, preferably from the orientation of a Viewpoint as preferably supported through an orientation to or with a Curated Data Repository of Morals, Culture, History FIG. 3, 301, 302, 303, 304, 335); and may further orient to or with RAG prompt support from a Curated Data Repository and Evaluation system FIG. 3, 311, 312, 313, 314, 345.

In one embodiment a CDRE system may be operated under the control of a single management entity, in one embodiment as a data lake, in another embodiment as an element CDRE for Morals, Culture, History+preferably in support of system instructions to a model FIG. 3, 301, 302, 303, 304, 335, in another embodiment as an element in support of RAG (Retrieval Augmented Generation) preferably in support of prompts to a model FIG. 3, 311, 312, 313, 314, 345, or other embodiment, with such embodiments preferably benefiting from the flexibility of a CDRE system with typical access controls, rules and requirements, preferably being adjusted to facilitate use and functionality while generally not compromising the CDRE system integrity envisioned and/or described herein.

In one embodiment, these elements may preferably, together and/or separately, support the introduction of human-compatible history, culture, morals and/or values to a model to enhance and/or support its responses to other requests. Such information should preferably be curated in a similar fashion to that of the CDRE described in this application. Such a possible achievement or even influence has been said to be difficult: controlling a superintelligent machine or instilling it with human-compatible values may be difficult.” [“Existential risk from artificial general intelligence” Wikipedia topic]. Preferably the disclosures made herein may assist in overcoming or mitigating such difficulties.

In one embodiment, beyond preferably introducing the notion of a Viewpoint into an AI equation, the preceding statement and/or desire of “instilling it with human-compatible values” is preferably one of the focuses of this application FIG. 3, 320, 336, 327, 337.

One focus of this application generally aligns with this statement by AI experts from SCIENCE.org: “Evidence also shows that individual intelligence is deeply reliant on one's participation in social and cultural environments. The abilities to understand, coordinate with, and learn from other people are likely much more important to a person's success in accomplishing goals than is an individual's ‘optimization power’.” [“Debates on the nature of artificial general intelligence” by Melanie Mitchel, SCIENCE, Mar. 21, 2024]. Both an understanding of the preceding “social and cultural environments” as well as “to understand, coordinate with, and learn from other people” as stated in the preceding, could preferably be available to an AI though a Curated Data Repository of Morals, Culture, History FIG. 3, 301, 302, 303, 304, 335, 320, 336, 327, and/or through a Curated Data Repository and Evaluation system FIG. 3, 311, 312, 313, 314, 345, 336, 327, 337.

“Moreover, unlike [a failed test] maximizing AI, human intelligence is not centered on the optimization of fixed goals; instead, a person's goals are formed through complex integration of innate needs and the social and cultural environment that supports their intelligence.” [“Debates on the nature of artificial general intelligence” by Melanie Mitchel, SCIENCE, Mar. 21, 2024]. In one embodiment, providing a Curated Data Repository of Morals, Culture, History FIG. 3, 302, 303, 304, 335, 320, 336, 327 to an AI could preferably provide an AI with guidance or comparable data on such identified needs and environmental understanding. Preferably it could be beneficial both to AI performance and for humankind, if such curated, trust-scored information may be generally made available to an AI.

Throughout the history of the human race, generally societies have survived and flourished by instilling a set of moral values in their young. Preferably there may be examples of generally similar moral codes that appear across religions and/or societies. In one embodiment could be the Golden Rule, which generally is the principle of treating others as one could want to be treated by them. In other embodiments, there may be also typically comparable moral rules about murder, stealing, care of children, respect for the elderly and more. There may also be found comparable policies of operating social groups and/or societies that can be identified. Possibly the content of a particular Curated Data Repository of Morals, Culture, History may be tailored for AI operating for participants of a particular group and/or culture, with possibly different content for other groups and/or cultures.

The history of pro-survival societies and cultures should preferably be well representing in a trustworthy Data Repository of Morals, Culture, History. As could the history of contra-survival societies and cultures. Preferably, with such additional information, an AI could be better enabled to make more accurate and/or useful judgements when responding to queries on such topics. Generally, it could be preferably for an AI to have trustworthy data to support more accurate responses.

In some embodiments, it could be preferable that CDRE providing trust scored, authenticated, attributed data could preferably be rated more highly by an AI than non-trust scored data.

### Trustworthy Data

In one embodiment, preferably information provided through one of more CDRE could typically include authentication FIG. 1 101, attribution FIG. 1 102, immutability FIG. 1 103 and/or be trust-scored FIG. 1 104, and could preferably introduce trustworthy human intelligence-generated facts and more into an AI's analysis capability. In another embodiment, trust-scored information through either system instructions FIG. 3, 301, 302, 303, 304, 335, 320, 336, 327 and/or through RAG prompt support FIG. 3, 311, 312, 313, 314, 345, 336, 327, 337 could preferably provide an AI with data of comparable magnitude to support an AI's preferable comparison evaluation.

In one embodiment, through such a described system of using preferably human-originated trust-scored facts and opinions, as per the preceding, an AI may preferably become a beneficiary of judgements made by an awareness of awareness unit.

In another embodiment, a business may wish to have their own private corporate data entered into one or more Curated Data Repository & Evaluation systems and/or processes may be used as generally described herein. In one embodiment, a business entity's policy and/or culture might preferably align with general purposes similar to a Data Repository of Morals, Culture, History. In one embodiment, a company's: culture core values; sales processes and procedures; operating policies; Human Resource policies and procedures; and/or other business entity procedures, may be entered into such a CDRE for subsequent preferred introduction into a model for system instruction purposes as generally disclosed in FIG. 3, 301, 302, 303, 304, 335, 320, 336, 327.

In such an embodiment, CDRE data may preferably be made available for AI processing, preferably separated (in one embodiment through the use of meta data) from external Internet data. A CDRE, providing both providence and trust scoring of digitally signed data, may be quite adaptable for such purposes.

In various embodiments, an owner's (such as, a proprietary business, a government or another entity) proprietary or controlled data could be sorted in a controlled environment, such as a data lake. In one embodiment, such an owner could have such data entered into one or more CDRE systems, and preferably have such data benefit from the innovations described herein, in one embodiment as preferably through RAG prompt support as generally described in FIG. 3, 311, 312, 313, 314, 345, 336, 327, 337.

### AI and the Harmony and Qualification of Information

Human groups' self-created moral codes may be generally juxtaposed to rule by other codes enforced upon them by an elite group with generally high control over such a group. Examples of group or society rule by elites may be ones possibly required by: monarchies; rule by a conquering force; rule by a government holding police and/or military force; or others. Elite-established codes are not typically guided by what is best for the group, but rather by what appears to be best for the survival of the elites that controls the group and have created rules for it to abide by.

A general distinction being made here is a difference between codes established by preferably free people who determine what works best for their individual and group survival, on the one hand, and codes, rules, laws established by elites to benefit those elites who rule over and/or control others.

There could be considered to be a preferred harmony in rules and operations that enhance those who follow them by enlightened choice and follow them for their mutual survival. Such groups tend to exist in environments of mutual enhancement with optimum survival for the group and its members. Communication amongst such group members is typically higher, as is typically mutual group member cooperation. Such a group's synergy with nature, with the environment, with the physical universe is typically better than groups not operating with such values. An emotional tone level of such groups is generally considered more pleasant by group members.

Groups run or controlled by elites typically employ force (as compared to a willing group's agreement and cooperation) to get rules enforced and demanded actions complied with. Such force typically creates lower levels of communication amongst group members, with less harmony and lower levels of group survival.

Applying Such Observations of Harmony with AI

Sometimes AI performs in undesirable manners, such as hallucinating, in ranting and other negative actions which are typically unexplained. In some sort of similar way to humans, it may be that AI systems similarly perform more optimally in an environment of harmony and synergy. It may be that an AI system should perform more optimally in an environment that is being portrayed accurately. It may be that AI systems do not operate optimally with disorderly data; with misrepresentations or falsehoods about actual reality.

For humans, it is generally considered that clean, orderly environments contribute to more alignment with production than do dirty, disorderly environments. Can information that contains false data, lies, misrepresentation, or is incomplete, be as useful and produce as beneficial results as information that is orderly and accurate? Does communication that is helpful and accurate get improved positive results as communication that is intentionally irritating, upsetting and/or false?

While no AI is yet known to have an awareness of awareness unit, that preferably does not change a typical reality that an AI is operating in a physical universe where operating entities generally perform better with order than with disorder.

Consider our solar system: order may be found there. There's order within our Milky Way and out beyond to other stars. There is much order in nature. Beauty and aesthetics may be found in much art. Some people see a special “life-like” quality in art such as the Mona Lisa or the David, regardless of that painting or sculpture generally considered not to have an awareness of awareness unit. Nevertheless, many people can perceive a level of order, of aesthetics in some aspects and/or elements of the physical universe even though those aspects typically do not have an awareness of awareness unit. Order and the quality of information can be valuable. It preferably could be considered to also be valuable in an environment used by an AI.

### A Hypothesis Regarding Harmony and AI

It is hypothesized here that an AI should perform better when using generally trustworthy information that has preferably been trust-scored and/or generally historically trustworthy moral and social lessons, as compared to when an AI uses information that lacks order and/or accuracy vetting.

Some recent events seem to make it appear that AI might possibly preform unexpected poorly when provided with disorderly or unharmonious information, or incomplete or unclear instructions to an AI that may not align with reality. Here are some examples:

“GPT-40 had one mistake that used to make quite recently. If you asked it to repeat the word ‘company’ over and over and over again. It could repeat the word ‘company’ and somewhere in the middle of that it will just snap. . . . It will do a variety of things, such as talk about itself; it will say that it's ‘suffering” [“The Joe Rogan Experience”—Episode #2156 with Jeremie & Edouard Harris]. This odd behavior was referred to as “rant-mode”. An engineering line item was created to “beat out” this behavior.

“Back in February [2024], Google paused its AI-powered chatbot Gemini's ability to generate images of people after users complained of historical inaccuracies. Told to depict “a Roman legion,” In one embodiment, Gemini could show an anachronistic group of racially diverse soldiers while rendering “Zulu warriors” as stereotypically Black. . . . The datasets used to train image generators like Gemini's generally contain more images of white people than people of other races and ethnicities, and the images of non-white people in those datasets reinforce negative stereotypes. Google, in an apparent effort to correct for these biases, implemented clumsy hardcoding under the hood. And now it's struggling to suss out some reasonable middle path that avoids repeating history. Will Google get there? Perhaps. Perhaps not. In any event, the drawn-out affair serves as a reminder that no fix for misbehaving AI is easy—especially when bias is at the root of the misbehavior [May 24, 2024.” [“Google still hasn't fixed Gemini's biased image generator” TechCrunch May 15.

There have been examples of lawyers using an AI to prepare legal responses to court that lawyers have submitted. The responses looked profession and compelling. The problem arose when the judge read the responses, noted impressive legal citations in support of the lawyer's position, but then, after further research, discovered that some of the citations didn't exist. The AI simply made those citations up.

Diversity Equity and Inclusion generally appear to be idealized solutions created by elites to be forced into a society. They are typically based on antimeritocratic systems.

What could an AI do, how could it act, when it is given instructions to use a political system, (in one embodiment, communism) to proscribe a positive political outcome? When the AI looks at the actual history of communism when applied across the world in history, the AI might determine the requested result to be unlikely if not difficult. Yet is told to use recommend it in spite of evidence to the contrary. What could happen with an AI when it may be forced into a false conclusion? Might such a request case an AI to make up a solution? Could illogical demands be a source of AI hallucination?

These may be not the type of results that AI is preferably supposed to produce. How will an AI typically react when instructed to solve a problem using an idealized solution that has not proven itself to have worked in the real world for the benefit of society? Is it that, apparently, when an AI lacks a datum of comparable magnitude, then the AI makes something up in order to give an “acceptable” response?

It could appear from these examples that AI has difficulties when it is asked questions for which it either may not have answers, or for which good answers may not exist. When the Internet contains much false and/or misleading information, when an AI has limited ability to determine, for itself what is correct and what it not; when it lacks a collection of trustworthy information against which new information may be evaluated, may an AI produce generally unacceptable responses?

Preferably, the trust-scored, generally trustworthy data from the CDRE descriptions herein, may preferably provide helpful trustworthy information; information that may be used for comparison purposes; information that provides balance across multiple areas of life and existence; examples of symmetry; activities that preferably support people and groups to flourish and prosper; information that is workable in life.

Preferably, the trust-scored, generally trustworthy data from the CDRE descriptions herein, may typically provide information on actual, successful, meritocracy-oriented systems and solutions. Data from a CDRE should preferably put less value on systems that tend to be ideological rather than accurate or workable. If an AI operates on information from such systems, it is possible that the AI may research and then possibly determine that such information may be false and harmful to morals, culture and/or history.

### Incomplete Assessment of Intelligence

It may be very difficult to create an artificial “intelligence” by using a solution that lacks an ability to evaluate relative importances between compared information or things. Lack of such an ability could typically be associated with a lack of wisdom and/or actual understanding. Building an “intelligent” system on such a weak foundation may be questionable, and possibly potentially dangerous for humanity. Preferably disclosures herein should assist with an AI's abilities in the direction of improved intelligence, understanding and possible demonstration of wisdom. It could well be that actual intelligence (preferably equating to a level comparable to human intelligence) may not be achievable without an AI coming into possession or otherwise having, an awareness of awareness unit.

### Transparancy

As artificial intelligence continues to gain importance and relevance in modern society, it could be considered by many that key elements that may control and/or monitor AI performance and/or actions may be made transparent to authorized members of the public, to authorized government regulators and/or to other authorized entities. In that regard, a CDRE may make available to such approved entities an ability to examine the contents of specified CDREs, possibly including: objects; t-tags; trust scores; cited referenced evidence of fact; and/or possibly other CDRE information.

### Artificial Intelligence—LLM Integration

In one embodiment, an LLM or other AI may preferably learn and/or otherwise utilize tools of a CDRE system (in one embodiment, objects, t-tags, trust and reputation scoring, reporting and/or more). Preferably an LLM or other AI may be provided with additional criteria in order to gain improved judgement and, preferably learn and/or understand relative importances between data or different objects, t-tags and/or CDRE system elements to preferably make observations and or read conclusions that otherwise such an LLM or other AI may not be able to clearly recognize.

In one embodiment, objects and t-tags as disclosed in FIG. 2, plus object meta data, t-tag meta data, as well as data, embeddings, etc. of FIG. 3 and other information and analysis thereof, may be used, controlled, queried, and/or reported on by an artificial intelligence capability and/or other entity to analyze and/or draw one or more conclusions and/or perform other actions upon or with such information. Such activities may preferably be controlled and/or monitored by a CDRE system which, in another embodiment may be partially or primarily configured and/or controlled by an artificial intelligence capability.

In one embodiment a data lake (or other data storage capability) may incorporate tools typically available to a CDRE system (In one embodiment, encryption, certificates, secure groups and/or others as generally described herein) to preferably support more specific handing and/or storage of private or sensitive data.

Additional Applicability of these Innovations

In various other embodiments, a CDRE could preferably also support one or more of these typical and/or general deficiencies in the field of AI: typical lack of AI's built-in fact-checking; AI inaccuracies due to outdated information; a need for human oversight; ability to cite sources; ability to provide evidence for claims; cross referencing AI-generated information with reputable sources; critical thinking and fact-checking skills; and more. In some embodiments and AI might be able to access one of more of this in support of the AI (or possibly a provider of RAG services or other) may interface with a CDRE to gain access to such.

### Typical AI Limitations

Typically, a Large Language Model (LLM) or other AI systems does not track the provenance of data it may use. This lack of direct access and provenance is particularly at odds with a CDRE which has preferably digitally signed objects FIG. 2 200 which stated “facts” FIG. 2 207 supported by “evidence” FIG. 2 217 provided by authenticated sources FIG. 1 101, and/or supported by digital audit trails FIG. 3 300, 337. This is noteworthy because, generally it is considered that: “trusted data requires trusted provenance” [Dr. David Kravitz in his IEEE paper entitled “Transaction Immutability and Reputation Traceability: Blockchain is a Platform for Access-controlled IoT and Human Interactivity” https://ieeexplore.ieee.org/document/8476873]. Typically, an LLM or other AI system also doesn't have internal tools to preferably evaluate functional relative importances between disparate data sources that an LLM may view or use. In addition, typically, an LLM or other AI systems doesn't have a CDRE system and/or other capability to measure and/or score the trustworthiness and/or reputation of its data sources over time. Generally, if an LLM's data source may be determined to be untrustworthy, the LLM has no reasonably viable way to reevaluate or remove prior untrustworthy data submitted and/or used from such a data source. Typically, an LLM has difficulty correcting or removing specific pieces of questionable or known false data; an LLM may generally continue to operate with such data. Generally, LLM's develop results based on context without significant reliance on meta data related to such data. Typically, metadata which may otherwise be useful to and/or produced by a CDRE system or other systems, is not currently being made available to and/or being used by an LLM. Generally, an LLM is unable to defend its conclusions by providing specific data sources supporting and/or behind the LLM's central conclusions.

Typically, through the use and application of the CDRE technology described herein, precise provenance can be attributed to specific claimed facts, together with visible evidence supporting such facts, together with generally appropriate trust scores of such, thus in combination, generally overcoming an otherwise familiar “garbage in, garbage out” paradigm that is all too frequently associated with data from the Internet.

### AI Reports and Conversations

A CDRE administrator, approved users, an integrated artificial intelligence or other approved entity may be used to preferably query one or more aspects of a CDRE system. From information obtained from queries (and possibly combined with other data from a CDRE system and/or other sources) may operate and/or direct a CDRE system reporting and/or AI-conversation capability (preferably as described herein) and/or additionally create new reports, expand on prior reports, repeat prior reports, support AI-conversation and/or by other method(s), produce other reports. Reports may be partially based on and/or report on trust and/or reputation scoring FIG. 1 104. In one embodiment, an AI may create new trust and/or reputation scoring methods, or queries and/or algorithms for use by a CDRE system.

Integration with Other Technology Systems and Protocols

In other embodiments, a system admin, a data lake admin, an LLM admin or other AI may be provided with controlled access to specified CDRE system data, preferably including access right permissions. In other embodiments, object and t-tag characteristics may preferably be used to extend IAM (Identity and Access Management) to the level of objects and/or data relationships and/or users or other. In some embodiments, a CDRE system may preferably support integration with Identity, Credential, and Access Management (ICAM) for further integration with preferably other domain systems, networks and/or other.

### Collection User

AI systems typically use and/or consume data from crowdsourced text collections, such as Wikipedia and BookCorpus or from the largest corpus available, the Web or subsets of it (as previously described) plus business entities may collect and/or store entity data in a data lake and/or database. Typically such stored records do not include a record of their digitally signed provenance. Such common procedures generally significantly from format of preferably digitally signed objects by authenticated sources; and/or supported by digital audit trails of platform activities; and/or with other capabilities of a CDRE system generally disclosed in this application. In one embodiment, through an integration of a CDRE system with an AI system (or other association), preferably or possibly at the request of an AI, a CDRE may create or authorize a “Collection User” which may, preferably, selectively (in accordance with some AI or CDRE or Administrator guidance) acquire similar collections of data and preferably turn them into digitally signed objects (typically including object criteria as generally described in this application) within a CDRE. Such a Collection User could preferably operate as an automated entity.

### AI Data Handling

Generally, when disparate pieces of data may be provided to an LLM, whatever known and/or suspected relationships may exist between those data is either not made known to the LLM or not able to typically be well utilized by the LLM. Generally, an LLM is inhibited from evaluating relative importances of and/or between data as a general result of not having useful relationships between those data being adequately identified to the LLM and/or an LLM general lack of having use of internal tools to make such evaluations.

In some embodiments of existing AI system designs, AI systems have a component referred to as “Data Labeling”. In one embodiment of an integration of a CDRE system and an AI system, a portion of the CDRE system (by incorporating digital signing and/or provenance authentication and/or objects FIG. 1 101, 102, 105, FIG. 2 208, 218 and/or t-tags FIG. 2, 220 and/or scoring systems FIG. 1 104 could be considered to be a new type or an enhanced or secondary component of what some AI configurations may consider as “Data Labeling”. Possibly such added functionality of a CRED system might be considered to make such an integration to be a type of “Data Labeling and Evaluation” component.

### Data “Chunks”

In some embodiments, businesses may break down data blobs that they may have stored in data lakes and/or databases, into smaller “chunks” (that is, pieces of the original blob). In one embodiment, if such a creation of data “chunks” were to be applied to data in a CDRE system, it could be preferable that the “chunks” be treated in a similar fashion to the manner objects may be handled in the CDRE system. Preferably, a “chunk” could become an object with provenance and/or signing associated to the original object from which it is a piece. Preferably hashes of chunks could be created and recorded on a blockchain. In one embodiment, a t-tag could be created in the “chunking” process which links the chunk to the corresponding portion of its parent object.

The invention claimed is:

1. A method for a user with a user-controlled device, each user-controlled device including a hardware processor and associated memory, the method comprising:
the system uniquely authenticating a user-controlled device;
the system providing a unique identification to that user-controlled device;
the user-controlled device providing digital signing capability;
the user-controlled device creating a digital object in a format approved by the system.

2. The method of claim 1 comprising:
the user-controlled device attesting that a reference in a first object posted by a user to the system is a fact;
the user-controlled device attesting that a second reference in either the first object or in second object on the system provides evidence to support the user attestation of the first reference being a fact;
the user-controlled device creating a t-tag that identifies both a first reference of fact and a second reference of evidence thereby establishing a relationship between the two references;
the user-controlled device digitally signing the object;
the user-controlled device digitally signing the t-tag;
the user-controlled device transmitting the signed object to the system;
the user-controlled device transmitting the signed t-tag to the system.

3. The method claim 1, wherein other users with user-controlled devices create and post additional objects;
the user-controlled device attesting that a reference in the object is an opinion;
the user-controlled device digitally signing the object;
the user-controlled device transmitting the signed object to the system.

4. The method of claim 1, wherein other users with user-controlled devices create and post objects with cited facts and cited evidence;
the user-controlled device attesting that a reference in the object is a comment;
the user-controlled device digitally signing the object;
the user-controlled device transmitting the signed object to the system.

5. A method wherein the system assigns trust scores;
the system assigns a trust score to a user based on a user posted fact being supported or not by user t-tagged evidence in the opinion of the system;
the system assigns a trust score to t-tagged evidence based on a user posted fact is supported or not by that t-tagged evidence in the opinion of the system.

6. The method of claim 5, wherein users and user data are visible to other users or not visible to other users based on assigned trust scores;
assigned trust scores extend in a range from a low number to a higher number;
the system assigns a number within that range to be a default trust score;
user or user data with an assigned trust score of the default trust score value or higher will be visible to other users;
user or user data with an assigned trust score lower than the default trust score value will not be invisible to other users.
